(19) United States
(12) Patent Application Publication
(10) Pub. No.: US 2026/0079761 A1
(43) Pub. Date: Mar. 19, 2026

(54) METHOD AND APPARATUS FOR CONFIGURING RELAY REGISTER MODULE, AND COMPUTING DEVICE AND READABLE MEDIUM

(71) Applicant: MOORE THREADS TECHNOLOGY CO., LTD., Beijing (CN)

(72) Inventors: Lei CHEN, Beijing (CN); Si WEN, Beijing (CN); Maoxin SUN, Beijing (CN); Xiaojie GENG, Beijing (CN); Cheng HU, Beijing (CN)

(21) Appl. No.: 19/400,536

(22) Filed: Nov. 25, 2025

Related U.S. Application Data
(63) Continuation of application No. PCT/CN2024/095218, filed on May 24, 2024.

(30) Foreign Application Priority Data
May 26, 2023 (CN) 202310607003.0

(51) Int. Cl. G06F 9/50

(52) U.S. Cl. CPC G06F 9/5038; G06F 9/5033; G06F 9/5055

(57) ABSTRACT

The present disclosure relates to a method for configuring a relay register module, including: receiving a start allocation request for at least one task sent by a task scheduler; determining, based on the start allocation request, a number of relay registers to be allocated to each task of the at least one task; allocating the corresponding number of relay registers to each task; and sending a wake-up signal to the task scheduler in a case where the allocation is completed, the wake-up signal is used by the task scheduler to start a task to which relay registers are allocated; wherein the relay register module is configured to store an intermediate result obtained from an operation based on an instruction of the task. The present disclosure further relates to an apparatus for configuring a relay register module.

### TECHNICAL FIELD

The present disclosure relates to the technical field of chips, and particularly relates to a method and an apparatus for configuring a relay register module. Furthermore, the present disclosure also relates to a corresponding computing device, a computer program product and a computer-readable medium.

### BACKGROUND

General data registers may be used for storing information on attributes, private data and the like in respective pipelines of a central processing unit or a graphics processing unit, and a usage amount thereof is generally large. In the existing art, there is a problem of congestion waiting due to simultaneous accesses of the respective pipelines to a port of a general data register.

### SUMMARY

The present disclosure proposes a technical solution for configuring a relay register module, by which a relay register for storing an intermediate result obtained from an operation based on an instruction of a task is dynamically configured for the task, so that a problem of congestion waiting due to simultaneous accesses of respective pipelines to a port of a general data register can be alleviated.

According to one aspect of the present disclosure, there is provided a method for configuring a relay register module, including: receiving a start allocation request for at least one task sent by a task scheduler, determining, based on the start allocation request, a number of relay registers to be allocated to each task of the at least one task, allocating the corresponding number of relay registers to each task, and sending a wake-up signal to the task scheduler in a case where allocation is completed, the wake-up signal is used by the task scheduler to start a task to which relay registers are allocated, wherein the relay register module is configured to store an intermediate result obtained from an operation based on an instruction of the task.

According to some exemplary embodiments of the method, the start allocation request includes a working mode of the task and a number of relay registers to be allocated to each work item instance in the task, wherein determining, based on the start allocation request, the number of relay registers to be allocated to each task of the at least one task includes: determining the number of relay registers to be allocated to each task based on a granularity corresponding to the working mode of the task and the number of relay registers to be allocated to each work item instance in the task, wherein the granularity represents a maximum number of work item instances included in the corresponding task.

According to some exemplary embodiments of the method, the number of relay registers to be allocated to each work item instance in the task is determined based on a defined number of tasks that are simultaneously started.

According to some exemplary embodiments of the method, numbers of relay registers to be allocated to each work item instance in tasks of different working modes are different, and numbers of relay registers to be allocated to each work item instance in tasks of the same working mode are same or different.

According to some exemplary embodiments of the method, the number of relay registers to be allocated to each task is less than or equal to a reference value, wherein the reference value is determined based on a total number of the relay registers, a working mode of the task, and a configured maximum relay register usage amount.

According to some exemplary embodiments of the method, the task includes at least one work item instance, each work item instance is allocated with at least one relay register, and the method further includes: storing, in a case where a calculation result of a first instruction in the relay register is used up, a calculation result of a second instruction in the relay register, wherein the first instruction and the second instruction are instructions of the same work item instance, and the second instruction is a subsequent instruction of the first instruction.

According to some exemplary embodiments of the method, allocating the corresponding number of relay registers to each task includes: determining, based on the number of relay registers to be allocated to the task, an available line allocated to the task in the relay register module, wherein the available line is a relay register line available for allocation; and allocating relay registers in the available line to the task, and labeling the available line as an allocated relay register line.

According to some exemplary embodiments of the method, the available line includes an index value, the task includes a serial number, and the method further includes: acquiring the serial number of the task and the index value of the available line allocated to the corresponding task, and recording the serial number and the index value in a line address table, wherein the serial number is used for managing the line address table.

According to some exemplary embodiments of the method, the method further includes: in response to receiving an access request to the relay register module, generating a physical address of a relay register corresponding to the access request according to the serial number of the task included in the access request and the line address table, wherein the physical address is used for accessing the relay register module.

According to some exemplary embodiments of the method, the method further includes: in response to receiving a task ending signal, recovering a relay register allocated to a task corresponding to the task ending signal.

According to another aspect of the present disclosure, there is provided an apparatus for configuring a relay register module, including: a relay register controller configured to receive a start allocation request for at least one task sent by a task scheduler; and determine, based on the start allocation request, a number of relay registers to be allocated to each task of the at least one task; an allocation unit configured to allocate the corresponding number of relay registers to each task; and a notification unit configured to send a wake-up signal to the task scheduler in a case where allocation is completed, the wake-up signal is used by the task scheduler to start a task to which relay registers are allocated, wherein the relay register module is configured to store an intermediate result obtained from an operation based on an instruction of the task.

According to some exemplary embodiments of the apparatus, the start allocation request includes a working mode of the task and a number of relay registers to be allocated to each work item instance in the task, and the relay register controller is configured to determine the number of relay registers to be allocated to each task based on a granularity corresponding to the working mode of the task and the number of relay registers to be allocated to each work item instance in the task, wherein the granularity represents a maximum number of work item instances included in the corresponding task.

According to some exemplary embodiments of the apparatus, the number of relay registers to be allocated to each work item instance in the task is determined based on a defined number of tasks that are simultaneously started.

According to some exemplary embodiments of the apparatus, numbers of relay registers to be allocated to each work item instance in tasks of different working modes are different, and numbers of relay registers to be allocated to each work item instance in tasks of the same working mode are same or different.

According to some exemplary embodiments of the apparatus, the number of relay registers to be allocated to each task is less than or equal to a reference value, wherein the reference value is determined based on a total number of relay registers, a working mode of the task, and a configured maximum relay register usage amount.

According to some exemplary embodiments of the apparatus, the task includes at least one work item instance, each work item instance is allocated with at least one relay register, and the allocation unit is configured to store, in a case where a calculation result of a first instruction in the relay register is used up, a calculation result of a second instruction in the relay register, wherein the first instruction and the second instruction are instructions of the same work item instance, and the second instruction is a subsequent instruction of the first instruction.

According to some exemplary embodiments of the apparatus, the allocation unit is configured to determine, based on the number of relay registers to be allocated to the task, an available line allocated to the task in the relay register module, wherein the available line is a relay register line available for allocation; and allocate relay registers in the available line to the task, and label the available line as an allocated relay register line.

According to some exemplary embodiments of the apparatus, the available line includes an index value, the task includes a serial number, and the allocation unit is further configured to acquire the serial number of the task and the index value of the available line allocated to the corresponding task, and record the serial number and the index value in a line address table, wherein the serial number is used for managing the line address table.

According to some exemplary embodiments of the apparatus, the allocation unit is further configured to, in response to receiving an access request to the relay register module, generate a physical address of a relay register corresponding to the access request according to the serial number of the task included in the access request and the line address table, wherein the physical address is used for accessing the relay register module.

According to some exemplary embodiments of the apparatus, the allocation unit is further configured to, in response to receiving a task ending signal, recover a relay register allocated to a task corresponding to the task ending signal.

According to another aspect of the present disclosure, there is provided an electronic device, including: a processor; and a memory configured to store a processor-executable instruction; wherein the processor is configured to call the instruction stored in the memory to perform the method according to any one of the above embodiments.

According to another aspect of the present disclosure, there is provided a computer program product including an instruction which, when executed by a computing device, causes the computing device to perform the method according to any one of the above embodiments.

According to another aspect of the present disclosure, there is provided a computer-readable medium having an instruction stored thereon which, when executed, causes a computing device to perform the method according to any one of the above embodiments.

According to an embodiment of the present disclosure, the corresponding number of relay registers may be allocated to each task according to the start allocation request of the task, by dynamically configuring a relay register for storing an intermediate result obtained from an operation based on an instruction of a task, the problem of congestion waiting due to simultaneous accesses of respective pipelines to a port of a general data register can be alleviated.

### BRIEF DESCRIPTION OF DRAWINGS

Specific exemplary embodiments of the present disclosure will now be described with reference to the accompanying drawings. However, the present disclosure may be embodied in many different forms and should not be construed as being limited to the embodiments set forth herein; rather, the embodiments are provided so that the present disclosure will be thorough and complete, and will fully convey the scope of the present disclosure to those skilled in the art. The terms used in the detailed description of the particular exemplary embodiments illustrated in the accompanying drawings are not intended to be limiting of the present disclosure. In the accompanying drawings, like numerals refer to like parts throughout.

FIG. 1 shows a flowchart of a method 100 for configuring a relay register module according to an embodiment of the present disclosure.

FIG. 2 shows a schematic diagram of fixed bonding between relay registers and tasks (waves).

FIG. 3 shows a block diagram of an apparatus 300 for configuring a relay register module according to an embodiment of the present disclosure.

FIG. 4 shows a block diagram of an apparatus 400 for configuring a relay register module according to another embodiment of the present disclosure.

FIG. 5 shows a block diagram of an apparatus 500 for configuring a relay register module according to another embodiment of the present disclosure.

FIG. 6 shows a schematic diagram of dynamically allocating relay registers according to an embodiment of the present disclosure.

FIG. 7 shows a schematic diagram of interaction between a task scheduler and a relay register configuring apparatus according to an embodiment of the present disclosure.

FIG. 8 shows a schematic diagram of interaction between a task scheduler and a relay register configuring apparatus according to another embodiment of the present disclosure.

FIG. 9 shows a block diagram of a computing device according to an embodiment of the present disclosure.

### DETAIL DESCRIPTION OF EMBODIMENTS

To make objects, technical solutions and advantages of the present disclosure clearer and more understandable, the technical solutions of the present disclosure are further described below by referring to the accompanying drawings and embodiments. It will be further understood that terms “comprise”, “comprising”, “include” and/or “including”, when used in the present specification, specify presence of stated features, steps, operations, elements, and/or components, but do not preclude presence or addition of one or more other features, steps, operations, elements, components, and/or groups thereof.

In the existing art, general data registers may be used for storing information on attributes, private data and the like in respective pipelines of a CPU or GPU, and a usage amount thereof is generally large. For example, under normal circumstances, any work item instance of each task may be allocated with dozens to a maximum of over two hundred registers. Furthermore, the allocated number varies with the number of tasks. For example, if a single task uses a larger number of general registers, the number of tasks that can be started will inevitably be fewer, and even cannot be used according to the set maximum number of tasks. Meanwhile, the general data register is used by all pipelines, including an integer or floating-point ALU pipeline, a special arithmetic function pipeline, a texture sampling pipeline and the like, which may cause problems like congestion waiting due to simultaneous accesses of respective pipelines to a port of a general data register. A calculation ALU processing unit in a kernel runs in a high-frequency state of the kernel, and it is precisely this high-speed operation that requires reducing access congestion of the general data register so that kernel processing can achieve the best performance.

The present disclosure provides a method for configuring a relay register module, in which the relay register module may be configured to store an intermediate result obtained from an operation based on an instruction of a task, such as an intermediate result of a floating-point operation or a fixed-point operation. Therefore, the intermediate result used between previous and subsequent instructions may be read from the relay register immediately and used by the subsequent instruction, so that access pressure of the general data register can be reduced, the kernel processing can achieve a better performance, and running efficiency of a floating-point operation unit can be improved.

By storing the intermediate result of the instruction in the relay register, the subsequent instruction of the task in a pipeline may quickly access and obtain the intermediate result. The use of the relay register may reduce pressure of accessing the general data register in a floating-point logic operation unit pipeline and an integer logic operation unit pipeline, and the relay register has characteristics of rapid access, short period, high bandwidth, small capacity and the like. Moreover, a compiler may optimize a compiled instruction in a compiling process in cooperation with general data register resources and relay register resources, so that logic operation unit pipelines can achieve a better performance.

For facilitate understanding, the following description is given by taking an application to a GPU as an example, and the method for configuring the relay register module provided by the embodiments of the present disclosure may be applied to any application scenario.

The existing desktop GPU architecture basically uses pure single instruction multiple data (SIMD) 32 or pure single instruction multiple thread (SIMT) 32 of CUDA, a small core structure of such pure SIMD32 fixedly assembles 32 work item instances together for execution, and achieves excellent parallelism. The SIMD32 structure is commonly used in parallel programming, where 32 work item instances execute the same instruction behavior simultaneously. In some mobile GPU architectures, a large core structure, like SIMD128 where 128 work item instances are assembled together for execution, is commonly employed to reduce a core area and reduce power consumption. However, for a computation that does not require excessive complexity, the small core structure of the SIMD32 may increase times of thread scheduling, instruction issuing and instruction fetching, while the large core structure of the SIMD128 may cause serious resource waste for small tasks. Therefore, it is appropriate to adopt different structures for different use scenarios.

In the present application, a “wave” is a custom SIMD thread, a “wave32” represents a parallel thread warp assembled from 32 work item instances, and a “wave128” represents a parallel thread warp assembled from 128 work item instances.

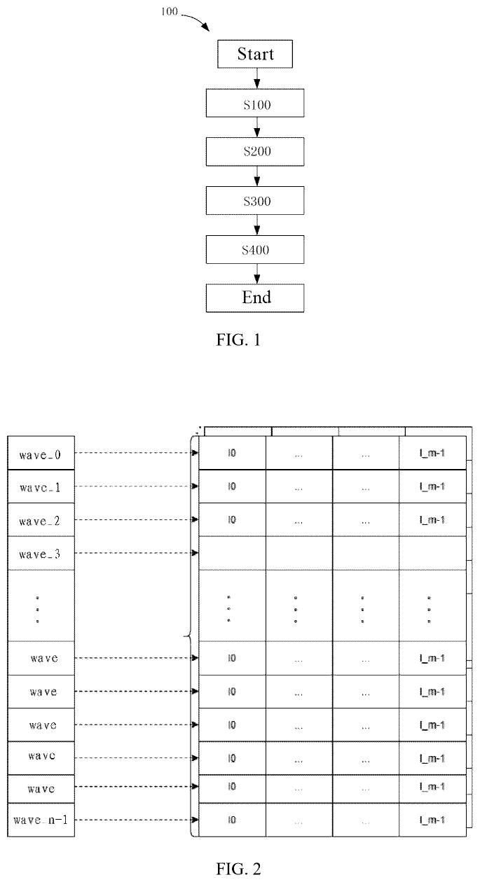

FIG. 1 shows a flowchart of a method 100 for configuring a relay register module according to an embodiment of the present disclosure. Illustratively, the method for configuring the relay register module of the present disclosure may be performed by an apparatus for configuring the relay register module, for example, the apparatus for configuring the relay register module in a GPU. As shown in FIG. 1, the method 100 includes: a step S100 of receiving start allocation request for at least one task sent by a task scheduler; a step S200 of determining, based on the start allocation request, the number of relay registers to be allocated to each task of the at least one task; a step S300 of allocating the corresponding number of relay registers to each task; and a step S400 of sending a wake-up signal to the task scheduler in a case where allocation is completed, the wake-up signal is used by the task scheduler to start a task to which relay registers are allocated, and where the relay register module is configured to store an intermediate result obtained from an operation based on an instruction of the task.

In this way, the corresponding number of relay registers may be allocated to each task according to the start allocation request of the task, and a relay register for storing the intermediate result obtained from the operation based on the instruction of the task is dynamically configured, so that the problem of congestion waiting due to simultaneous accesses of respective pipelines to a port of a general data register may be alleviated. Moreover, even if a small number of tasks are started since a certain task requires using a large number of general data register resources, more relay register resources may be allocated to tasks to be run based on the start allocation request, so that a relay register area which is otherwise idle in fixed allocation of relay registers is fully utilized, and thus an utilization rate of relay registers is increased.

The start allocation request may be a start allocation request for one or more tasks, and the wake-up signal sent to the task scheduler when the allocation is completed may be a wake-up signal sent in a case where allocation to all tasks corresponding to the start allocation request is completed or a wake-up signal sent for any one task to which allocation is completed. For one task, allocation being completed may represent that all relay registers that are determined to be allocated to the task have been allocated or a part of the relay registers that are determined to be allocated to the task has been allocated. Illustratively, if the apparatus for configuring the relay register module determines that currently available relay register lines are only a part of relay register lines to be allocated to the task, partial configuration may be performed. For example, if 4 lines of relay registers are to be allocated to the task, and only 2 lines of relay registers are currently available, allocation is determined to be completed when the 2 lines are allocated, and then the wake-up signal is sent to the task scheduler. It should be noted that in a case of the partial configuration, if it is determined that a parsed instruction indicates that more relay registers are needed after executing a partial code, the task may be blocked, and the task scheduler may re-issue the start allocation request so that the apparatus for configuring the relay register module performs a relay register configuration operation based on the start allocation request, which is not limited in the present disclosure. Illustratively, the task corresponding to the start allocation request sent by the task scheduler is a task that requires configuring relay registers as determined through compiling.

In the present application, the relay registers may be dynamically allocated to the corresponding task, and the number of relay registers and a relay register area allocated to each task may be dynamically changed. For example, when a small number of tasks are started since a certain task requires using a large number of general data register resources, more relay registers may be allocated to the started tasks to make full use of the relay register resources, thereby solving a problem of resource waste caused by fixed bonding of relay registers and tasks and relay register areas of idle tasks remaining unavailable when a small number of tasks are started.

Illustratively, tasks may include the wave32 and the wave128. Alternatively or additionally, the tasks may further include wave64 and the like. Illustratively, the start allocation request of the wave32 may include a working mode of the task, i.e., a wave32 mode, and the number of relay registers to be allocated to each work item instance in the task, which may be set to 2, 4, 6, 8 and the like according to the number of tasks which are simultaneously started. Illustratively, the start allocation request of the wave128 may include a working mode of the task, i.e., a wave128 mode, and the number of relay registers to be allocated to each work item instance in the task, which may be set to 2, 4 and the like according to the number of tasks which are simultaneously started. In some optional embodiments, the number of relay registers allocated to each work item instance in the task of the wave128 mode is smaller than the number of relay registers allocated to each work item instance in the task of the wave32 mode. In addition, the numbers of relay registers allocated to each work item instance in different tasks of the same working mode may be different. For example, the number of relay registers allocated to each work item instance in one wave32 is 2, while the number of relay registers allocated to each work item instance in another wave32 is 4.

In this way, different numbers of relay registers may be allocated to each task based on the start allocation request of the task. It should be noted that in order to be compatible with a plurality of task working modes and adopt the method of bonding relay registers with tasks, the relay registers corresponding to each task need to be designed according to a maximum execution granularity. For example, in order to be compatible with the wave32 mode and the wave128 mode, it is necessary to design according to an execution granularity of the 128 work item instances, which may result in high hardware implementation overhead. Moreover, if a large amount of data used in the general data registers causes that tasks are not fully started, the available number of relay registers for each task is fixed due to the bonding of relay registers and tasks, and in this case, a large number of relay register resources are idle but not available.

In the embodiments of the present disclosure, the relay registers may be dynamically allocated to each task without designing according to the maximum execution granularity of the plurality of working modes, so that hardware overhead can be effectively reduced. Under a condition of running in different modes, the relay register resources may be fully used without significantly increasing the overhead, thereby increasing use efficiency.

Illustratively, since the relay registers are not fixedly bonded to respective work item instances, after the number of relay registers allocated to each task is determined, the corresponding number of relay registers may be allocated to the corresponding task. When the allocation is completed, the wake-up signal is sent to the task scheduler, so that the task scheduler starts the task to which the relay registers are allocated. Illustratively, if a task in the task scheduler needs to be configured with relay registers, the task scheduler may block the task until a wake-up signal indicating that configuration of the relay registers for the task is completed. Then, the task scheduler may allow the task to participate in scheduling based on the received wake-up signal.

Determining, based on the start allocation request, the number of relay registers to be allocated to each task of the at least one task may include determining the number of relay registers corresponding to each task based on a task type. For example, for the task of the wave128 mode, the number of relay registers corresponding to the wave128 mode may be allocated, or the start allocation request may include the number of relay registers that is applied by the task, based on which the allocation is performed. How to determine the number of relay registers to be allocated to each task of the at least one task is not limited in the present disclosure.

In one possible implementation, the start allocation request includes the working mode of the task and the number of relay registers to be allocated to each work item instance in the task, where determining, based on the start allocation request, the number of relay registers to be allocated to each task of the at least one task includes: determining the number of relay registers to be allocated to each task based on a granularity corresponding to the working mode of the task and the number of relay registers to be allocated to each work item instance in the task, where the granularity represents the maximum number of work item instances included in the corresponding task.

Illustratively, the wave32 mode corresponds to a granularity of 32, and if the number of relay registers to be allocated to each work item instance in the wave32 is 4, the number of relay registers allocated to the wave32 is 32*4=128. Illustratively, the wave128 mode corresponds to a granularity of 128, and if the number of relay registers to be allocated to each work item instance in the wave128 is 2, the number of relay registers allocated to the wave128 is 128*2=256. In addition, 128 relay registers are allocated to the wave32 even if the number of work item instances included in the wave32 is less than 32. Likewise, 256 relay registers are allocated to the wave128 even if the number of work item instances included in the wave128 is less than 128.

As described above, when the plurality of working modes is compatible, for example, when the wave32 and the wave128 are used simultaneously, it is necessary to design according to on the maximum execution granularity mode if a bonding mode is adopted, i.e., based on the execution granularity of 128 work item instances of the wave128. In this way, when the wave32 is executed, a relay register space corresponding to 96 work item instances is idle, resulting in a great waste of resources. Through the implementation provided in the embodiments of the present disclosure, a larger usage amount of relay registers may be configured for each work item instance in the wave32, thereby increasing read-write efficiency.

In one possible implementation, the number of relay registers to be allocated to each work item instance in the task is determined based on the defined number of tasks that are simultaneously started.

Illustratively, in compiling, the compiler may determine the number of relay registers allocated to each work item instance by defining the number of tasks that are simultaneously started according to a quantity of general data register resources occupied by the task. Illustratively, the number of relay registers to be allocated to each work item instance in the task is inversely related (or negatively related) to the defined number of tasks that are simultaneously started. For example, the smaller the number of tasks that are simultaneously started, the larger the number of relay registers to be allocated to each work item instance in the task. In this way, more efficient utilization of the relay register resources can be achieved.

As discussed above, the numbers of relay registers to be allocated to each work item instance in tasks of different working modes may be same or different.

In one possible implementation, the numbers of relay registers to be allocated to each work item instance in tasks of different working modes are different, and the numbers of relay registers to be allocated to each work item instance in tasks of the same working mode are same or different.

Illustratively, the number of relay registers allocated to each work item instance in the task of the wave128 mode may be smaller than or equal to the number of relay registers allocated to each work item instance in the task of the wave32 mode. For example, 2 relay registers are allocated to each work item instance in the task of the wave128 mode, while 4 relay registers are allocated to each work item instance in the task of the wave32 mode. Apparently, depending on the number of tasks that are simultaneously started, other numbers of relay registers may be allocated to each work item instance in the two working modes. Additionally, it may be determined based on the working modes of the tasks that are simultaneously started. In addition, the numbers of relay registers allocated to each work item instance in different tasks of the same working mode may be different. For example, 2 relay registers are allocated to each work item instance in one wave32, while 4 relay registers are allocated to each work item instance in another wave32. Apparently, depending on the number of tasks that are simultaneously started, other numbers of relay registers may be allocated to each work item instance in the same working mode. Additionally, it may be determined based on the working modes of the tasks that are simultaneously started. In some optional embodiments, the numbers of relay registers allocated to each work item instance in different tasks of the same working mode may be same.

In this way, more efficient utilization of the relay register resources can be achieved.

The number of relay registers to be allocated to each task may be defined, and for example, may be less than or equal to a reference value.

In one possible implementation, the number of relay registers to be allocated to each task is less than or equal to the reference value, where the reference value is determined based on a total number of relay registers, a working mode of the task, and a configured maximum relay register usage amount.

Illustratively, it assumed that a total number of relay registers is K=M banks*N tasks*SIMD_Numb, each task is configured with a maximum relay register usage amount T for a single instance, aligned_size represents the number of double-words (DWs) contained in relay register lines in an aligned single instance, and aligned_line represents the number of relay register lines to be allocated. The number of tasks of the wave128 mode that can be supported by the number of relay registers is Num_of_Wave128=K/(SIMD_128*aligned_size*((T+aligned_size−1)/aligned_size)), waves exceeding Num_of_Wave128 will enter a blocked state because no relay register can be allocated. The number of tasks of the wave32 mode that can be supported by the number of relay registers is Num_of_Wave32=K/(SIMD_32*aligned_size*((T+aligned_size−1)/aligned_size)), waves exceeding Num_of_Wave32 will enter the blocked state because no relay register can be allocated.

In this way, the number of relay registers allocated to each task is flexibly selected within a certain range, while the maximum relay register usage amount is configured for each task, which ensures more efficient utilization of the relay registers while reducing a condition that a certain task is allocated with too many relay registers and then affects start of a new task.

In one possible implementation, the task includes at least one work item instance, each of which is allocated with at least one relay register, and the method further includes: storing, in a case where a calculation result of a first instruction in the relay register has been used up, a calculation result of a second instruction in the relay register, where the first instruction and the second instruction are instructions of the same work item instance, and the second instruction is a subsequent instruction of the first instruction.

Illustratively, the wave32 may include 1 or more and 32 or less work item instances, while the wave128 may include 1 or more and 128 or less work item instances. Alternatively, the wave128 may include 33 or more and 128 or less work item instances. Illustratively, each work item instance may be allocated with at least one relay register, such as 2, 4, 6 relay registers or the like. Each work item instance in the same task has its own relay register space, and for the same task, after a previous instruction is written back, the relay register space can be immediately provided for use by a next instruction after hiding and delaying through internal instruction scheduling of the task, and when the next instruction is written back again, a previous result may be directly overwritten as long as the previous instruction is guaranteed to be used up. For example, the same work item instance includes the first instruction and the second instruction, and the second instruction is the subsequent instruction of the first instruction. When a result of the first instruction has been used up, a result of the second instruction may be written into a relay register storing the first instruction, that is, to overwrite an intermediate result of the first instruction.

In this way, the relay register may be recycled without allocating excessive relay registers to each work item instance, thereby increasing the utilization rate of relay registers.

In one possible implementation, allocating the corresponding number of relay registers to each task includes: determining, based on the number of relay registers to be allocated to the task, an available line allocated to the task in the relay register module, where the available line is a relay register line available for allocation; and allocating relay registers in the available line to the task, and labeling the available line as an allocated relay register line.

Illustratively, a valid available line information table is used to manage the relay register lines in the relay register module. When a certain relay register line in the relay register module is available for allocation, a flag corresponding to the relay register line available for allocation in the valid available line information table is 1. When a certain relay register line in the relay register module is not available for allocation, for example, has been allocated or occupied, a flag corresponding to the relay register line not available for allocation in the valid available line information table is 0. Illustratively, when the relay register line available for allocation is allocated to a certain task, the flag corresponding to the relay register line in the valid available line information table becomes 0. Alternatively, when a certain relay register line in the relay register module is available for allocation, a flag corresponding to the relay register line available for allocation in the valid available line information table is 0. When a certain relay register line in the relay register module is not available for allocation, for example, has been allocated or occupied, a flag corresponding to the relay register line not available for allocation in the valid available line information table is 1. Correspondingly, when the relay register line available for allocation is allocated to a certain task, the flag corresponding to the relay register line in the valid available line information table becomes 1.

In this way, the relay register line may be dynamically allocated to each task.

In one possible implementation, the available line includes an index value, the task includes a serial number, and the method further includes: acquiring the serial number of the task and the index value of the available line allocated to the corresponding task, and recording the serial number and the index value in a line address table, where the serial number is used for managing the line address table.

Illustratively, each task is assigned with a serial number waveid in the task scheduler, and each task has a serial number different from those of other tasks in the task scheduler, that is, the task may be identified by the serial number. Illustratively, each available line corresponds to an index value bitid. In one example, the valid available line information table may be set to a 48-bits valid flag table, in which each 1 bit indicates that one relay register line is valid and available. Generally, 1 represents “available”, and 0 represents “used”. It is essentially equivalent to searching the x-th bit that is available, and then x is filled into the line address table together with the serial number waveid of the task. Illustratively, the serial number waveid of the task may be used to manage the line address table, so that a pipeline may access relay registers by simply sending the serial number of the task when accessing the relay registers. Illustratively, the valid available line information table may be continuously searched according to the number of relay registers allocated to the task, to configure a plurality of relay register lines for the task to use, and filling may be performed after every traversal.

In this way, the serial number of the task may be associated with the available relay register line in the relay register module, so that only the serial number of the task needs to be provided when the pipeline accesses the relay registers.

In one possible implementation, the method further includes: in response to receiving an access request to the relay register module, generating a physical address of a relay register corresponding to the access request according to the serial number of the task included in the access request and the line address table, where the physical address is used for accessing the relay register module.

Illustratively, since the line address table is managed by the serial number of the task, when the access request to the relay register module is received, the index value of the relay register line allocated to the task may be determined by the serial number of the task, the physical address (LineID and BankID) of the relay register line allocated to the task may be determined by the index value, and then an actual storage area of the relay register may be accessed.

In this way, a simple and efficient access to the actual storage area of the relay register may be achieved.

In one possible implementation, the method further includes: in response to receiving a task ending signal, recovering a relay register allocated to a task corresponding to the task ending signal.

Illustratively, after receiving a signal indicating that the corresponding task is executed by the pipeline, the task scheduler releases a space occupied by the task in the task scheduler, and sends the task ending signal containing the serial number of the task to the relay register controller. In response to receiving the task ending signal, the relay register controller notifies an allocation unit to recover the relay register line allocated to the serial number of the task. Illustratively, the allocation unit changes the bit of the index value corresponding to the serial number of the task in the valid available line information table from 0 to 1, indicating that it is available for allocation.

In this way, a storage space of the relay register may be recycled.

FIG. 2 shows a schematic diagram of fixed bonding between relay registers and tasks (waves).

As shown in FIG. 2, relay registers are fixedly bonded to waves, which is a fixed configuration and needs no allocation. The number of relay registers is also fixedly configured according to the maximum number of waves supported by the kernel, and the number of relay registers allocated to each wave cannot be changed according to the number of waves that are started. Therefore, when a wave requires a large number of general data register resources and fewer waves are started, relay register areas of idle waves are still not available, causing resource waste.

FIG. 2 schematically shows n waves, each of which is bonded with m relay registers, and total overhead is n*m*the number of SIMD instances. This size is always fixed, and only m relay registers may be used even if one wave is started. Limited by high overhead of relay registers, the number m of relay registers in each wave is commonly fixed to 2 or 4.

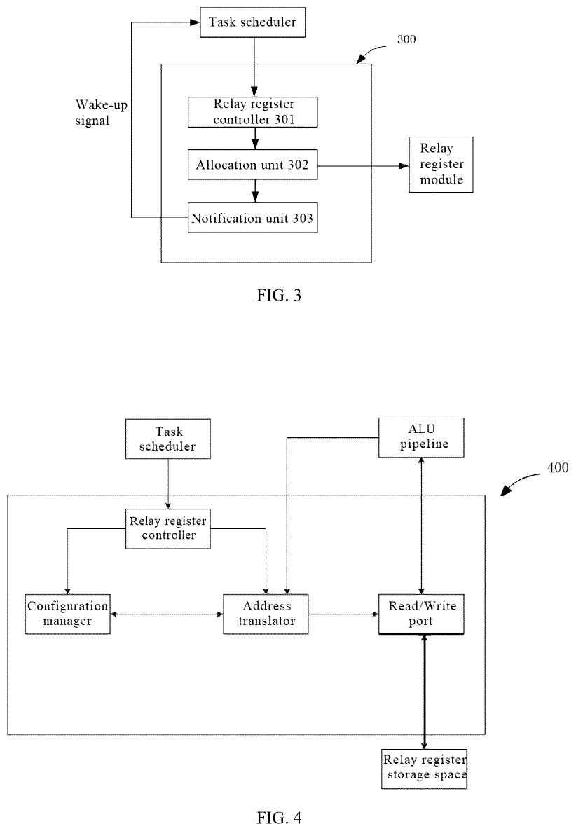

FIG. 3 shows a block diagram of an apparatus 300 for configuring a relay register module according to an embodiment of the present disclosure. This apparatus solves the problem based on a principle similar to the method in the above embodiments, and therefore, reference may be made to the above embodiments for specific implementation thereof.

As shown in FIG. 3, the apparatus 300 may include a relay register controller 301, an allocation unit 302, and a notification unit 303. The relay register controller 301 may be configured to receive a start allocation request for at least one task sent by a task scheduler; and determine, based on the start allocation request, the number of relay registers to be allocated to each task of the at least one task. In one example, the task scheduler sends the start allocation request for a plurality of tasks, which may include a wave32 and a wave128. Alternatively or additionally, the tasks may further include a wave64, and the like. Illustratively, the start allocation request of the wave32 may include a working mode of the task, i.e., a wave32 mode, and the number of relay registers to be allocated to each work item instance in the task, which may be set to 2, 4, 6, 8 and the like according to the number of tasks that are simultaneously started. Further, the relay register controller 301 may be configured to determine the number of relay registers to be allocated to each task based on a granularity corresponding to the working mode of the task and the number of relay registers to be allocated to each work item instance in the task, where the granularity represents the maximum number of work item instances included in the corresponding task. Illustratively, the wave32 mode corresponds to a granularity of 32, and if the number of relay registers to be allocated to each work item instance in the wave32 is 4, the number of relay registers allocated to the wave32 is 32*4=128. Illustratively, the wave128 mode corresponds to a granularity of 128, and if the number of relay registers to be allocated to each work item instance in the wave128 is 2, the number of relay registers allocated to the wave128 is 128*2=256. In addition, 128 relay registers are allocated to the wave32 even if the number of work item instances included in the wave32 is less than 32. Likewise, 256 relay registers are allocated to the wave128 even if the number of work item instances included in the wave128 is less than 128.

Illustratively, the number of relay registers to be allocated to each work item instance in the task is determined based on the defined number of tasks that are simultaneously started. For example, in compiling, the compiler determines the number of relay registers allocated to each work item instance by defining the number of tasks that are simultaneously started according to a quantity of general data register resources occupied by the tasks. In this way, more efficient utilization of the relay register resources can be achieved.

Illustratively, the numbers of relay registers to be allocated to each work item instance in tasks of different working modes are different, and the numbers of relay registers to be allocated to each work item instance in tasks of the same working mode are same or different. For example, the number of relay registers allocated to each work item instance in the task of the wave128 mode is smaller than the number of relay registers allocated to each work item instance in the task of the wave32 mode. For example, 2 relay registers are allocated to each work item instance in the task of the wave128 mode, while 4 relay registers are allocated to each work item instance in the task of the wave32 mode. Apparently, depending on the number of tasks that are simultaneously started, other numbers of relay registers may be allocated to each work item instance in the two working modes. Additionally, it may be determined based on the working modes of the tasks that are simultaneously started. In addition, the numbers of relay registers allocated to each work item instance in different tasks of the same working mode may be different. For example, 2 relay registers are allocated to each work item instance in one wave32, while 4 relay registers are allocated to each work item instance in another wave32. Apparently, depending on the number of tasks that are simultaneously started, other numbers of relay registers may be allocated to each work item instance in the same working mode. Additionally, it may be determined based on the working modes of the tasks that are simultaneously started. In some optional embodiments, the numbers of relay registers allocated to each work item instance in different tasks of the same working mode may be same. In this way, more efficient utilization of the relay register resources can be achieved.

Illustratively, the number of relay registers to be allocated to each task is less than or equal to a reference value, where the reference value is determined based on a total number of relay registers, a working mode of the task, and a configured maximum relay register usage amount. For example, it assumed that a total number of relay registers is K=M banks*N tasks*SIMD_Numb, each task is configured with a maximum relay register usage amount T, aligned_size represents the number of DWs contained in relay register lines in an aligned single instance, and aligned_line represents the number of relay register lines to be allocated. The number of tasks of the wave128 mode that can be supported by the number of relay registers is Num_of_Wave128=K/(SIMD_128*aligned_size*((T+aligned_size 1)/aligned_size)), waves exceeding Num_of_Wave128 will enter a blocked state because no relay register can be allocated. The number of tasks of the wave32 mode that can be supported by the number of relay registers is Num_of_Wave32=K/(SIMD_32*aligned_size*((T+aligned_size−1)/aligned_size)), waves exceeding Num_of_Wave32 will enter the blocked state because no relay register can be allocated. In this way, the number of relay registers allocated to each task is flexibly selected within a certain range, while the maximum relay register usage amount is configured for each task, which ensures more efficient utilization of the relay registers while avoiding a condition that a certain task is allocated with too many relay registers and then affects start of a new task.

The allocation unit 302 may be configured to allocate the corresponding number of relay registers to each task. Illustratively, the allocation unit 302 may determine, based on the number of relay registers to be allocated to the task, an available line allocated to the task in the relay register module, where the available line is a relay register line available for allocation; and allocate relay registers in the available line to the task, and label the available line as an allocated relay register line. Illustratively, a valid available line information table is used to manage the relay register lines in the relay register module. When a certain relay register line in the relay register module is available for allocation, a flag corresponding to the relay register line available for allocation in the valid available line information table is 1. When a certain relay register line in the relay register module is not available for allocation, for example, has been allocated or occupied, a flag corresponding to the relay register line not available for allocation in the valid available line information table is 0. Illustratively, when the relay register line available for allocation is allocated to a certain task, the flag corresponding to the relay register line in the valid available line information table becomes 0. Alternatively, when a certain relay register line in the relay register module is available for allocation, a flag corresponding to the relay register line available for allocation in the valid available line information table is 0. When a certain relay register line in the relay register module is not available for allocation, for example, has been allocated or occupied, a flag corresponding to the relay register line not available for allocation in the valid available line information table is 1. Correspondingly, when the relay register line available for allocation is allocated to a certain task, the flag corresponding to the relay register line in the valid available line information table becomes 1. In this way, the relay register lines may be dynamically allocated to each task.

The available line includes an index value, the task includes a serial number, and the allocation unit 302 may be further configured to acquire the serial number of the task and the index value of the available line allocated to the corresponding task, and record the serial number and the index value in a line address table, where the serial number is used for managing the line address table.

Illustratively, each task is assigned with a serial number waveid in the task scheduler, and each task has a serial number different from those of other tasks in the task scheduler, that is, the task may be identified by the serial number. Illustratively, each available line corresponds to an index value bitid. In one example, the valid available line information table may be set to a 48-bits valid flag table, in which each 1 bit indicates that one relay register line is valid and available. Generally, 1 represents “available”, and 0 represents “used”. It is essentially equivalent to searching the x-th bit that is available, and then x is filled into the line address table together with the serial number waveid of the task. Illustratively, the serial number waveid of the task may be used to manage the line address table, so that the pipeline may access the relay registers by simply sending the serial number of the task when accessing the relay registers. Illustratively, the valid available line information table may be continuously searched according to the number of relay registers allocated to the task, to configure a plurality of relay register lines for the task to use, and filling may be performed after every traversal. In this way, the serial number of the task may be associated with the available relay register line in the relay register module, so that only the serial number of the task needs to be provided when the pipeline accesses the relay registers.

The allocation unit 302 may be further configured to, in response to receiving an access request to the relay register module, generate a physical address of a relay register corresponding to the access request according to the serial number of the task included in the access request and the line address table, where the physical address is used for accessing the relay register module. Illustratively, since the line address table is managed by the serial number of the task, when the access request to the relay register module is received, the index value of the relay register line allocated to the task may be determined by the serial number of the task, the physical address (LineID and BankID) of the relay register line allocated to the task may be determined by the index value, and then an actual storage area of the relay register may be accessed. In this way, a simple and efficient access to the actual storage area of the relay register may be achieved.

The allocation unit 302 may be further configured to, in response to receiving a task ending signal, recover relay registers allocated to a task corresponding to the task ending signal. Illustratively, after receiving a signal indicating that the corresponding task is executed by the pipeline, the task scheduler sends the task ending signal containing the serial number of the task to the relay register controller. In response to receiving the task ending signal, the relay register controller notifies the allocation unit to recover the relay register line allocated to the serial number of the task. The task scheduler releases a space occupied by the task in the task scheduler only after receiving a release and recovery complete signal from the relay register controller, and completes a release ending operation of the task. Illustratively, the allocation unit changes the bit of the index value corresponding to the serial number of the task in the valid available line information table from 0 to 1, indicating that it is available for allocation. In this way, a storage space of the relay register may be recycled.

Since the task includes the at least one work item instance, each of which is allocated with at least one relay register, the allocation unit 302 may be further configured to store, in a case where a calculation result of a first instruction in the relay register is used up, a calculation result of a second instruction in the relay register. The first instruction and the second instruction are instructions of the same work item instance, and the second instruction is a subsequent instruction of the first instruction. Illustratively, the wave32 may include 1 or more and 32 or less work item instances, while the wave128 may include 1 or more and 128 or less work item instances. Alternatively, the wave128 may include 33 or more and 128 or less work item instances. Illustratively, each work item instance is allocated with at least one relay register, such as 1, 2, 4, 6 relay registers or the like. Each work item instance in the same task has its own relay register space, and for the same task, after a previous instruction is written back, the relay register space can be immediately provided for use by a next instruction after hiding and delaying through internal instruction scheduling of the task, and when the next instruction is written back again, a previous result may be directly overwritten as long as the previous instruction is guaranteed to be used up. In this way, the relay registers may be recycled without allocating excessive relay registers to each work item instance (when not necessary).

The notification unit 303 may be configured to send the wake-up signal to the task scheduler when the allocation is completed. The wake-up signal is used by the task scheduler to start the task to which the relay registers are allocated. Illustratively, since the relay registers are not fixedly bonded to the respective work item instances, after the number of relay registers allocated to each task is determined, the corresponding number of relay registers need to be allocated to the corresponding task. The wake-up signal is sent to the task scheduler when the allocation is completed, so that the task scheduler starts the task to which the relay registers are allocated. Illustratively, if a task in the task scheduler needs to be configured with relay registers, the task scheduler blocks the task until a wake-up signal indicating that configuration of the relay registers for the task is completed. Then, the task scheduler allows the task to participate in scheduling.

FIG. 4 shows a block diagram of an apparatus 400 for configuring a relay register module according to another embodiment of the present disclosure.

The apparatus 400 may include a relay register controller, a configuration manager, an address translator, and a read/write port. In an alternative implementation, the apparatus 400 may include only the relay register controller, the configuration manager, and the address translator. The relay register controller may be configured to receive a start allocation request (e.g., including a serial number and a working mode of a task, and the number of work item instances included in the task, and the number of relay registers to be allocated to each work item instance) for at least one task from an upper stream (e.g., a task scheduler). The relay register controller may determine the number of required relay register lines to be allocated to each task according to the received start allocation request of the task, and send the number of required relay register lines to the configuration manager. The configuration manager may be configured to dynamically allocate relay registers based on the number of required relay register lines. When the configuration manager completes allocation and makes a response, the relay register controller sends a wake-up notification to inform the task scheduler that the allocation of the required relay registers of the task is completed, and the task may be started to participate in scheduling and executing.

When determining the number of required relay register lines, the relay register controller performs dynamic allocation for different tasks according to different numbers of relay register lines required by different tasks in a multi-mode mixed state. In particular, the relay register controller may increase/decrease the number of relay register lines used by the corresponding task in a case where the number of tasks that are simultaneously started is decreased/increased due to a specific use scenario.

The configuration manager maintains the valid available line information table, searches and manages related information in the table to acquire available and valid allocatable information, and updates contents in the valid available line information table. In one example, the configuration manager searches the valid available line information table from beginning to end, when the x-th bit is found to be identified as available (e.g., set to 1 to indicate that the line is available), and then the bit is identified as used (e.g., set to 0 to indicate that the line has been used), so that the line will not be occupied by other tasks. After allocating the available line to a task, the configuration manager sends the serial number of the task and a significant bit index value to the address translator. Then, the address translator records the serial number of the task and the significant bit index value in the line address table. Meanwhile, the configuration manager recovers a relay register in a releasable task, and updates and updates related contents in the valid available line information table for use of subsequent tasks. In one example, when execution of the task is finished, the configuration manager identifies the corresponding line in the available line information table as available (e.g., set to 1 to indicate that the line is available).

The address translator manages the line address table according to serial numbers of tasks. In one example, the address translator limits the maximum number of tasks that can be started at one time in some application scenarios by configuring the maximum number of tables belonging to one task.

Additionally, when a pipeline accesses the relay register module, the address translator maps and generates a physical address, such as Line ID and Bank ID, of a relay register according to the access request and the line address table. Illustratively, since the line address table is managed by serial numbers of tasks, when the access request to the relay register module is received, an index value of a relay register line allocated to a task may be determined by the serial number of the task, the physical address (LineID and BankID) of the relay register line allocated to the task may be determined by the index value, and then an actual storage area of the relay register may be accessed. In this way, a simple and efficient access to the actual storage area of the relay register may be achieved.

Additionally, the read/write port may be configured to be used by an ALU pipeline to access the relay register based on the physical address via the read/write port. In an alternative implementation, the read/write port may be provided on the relay register module.

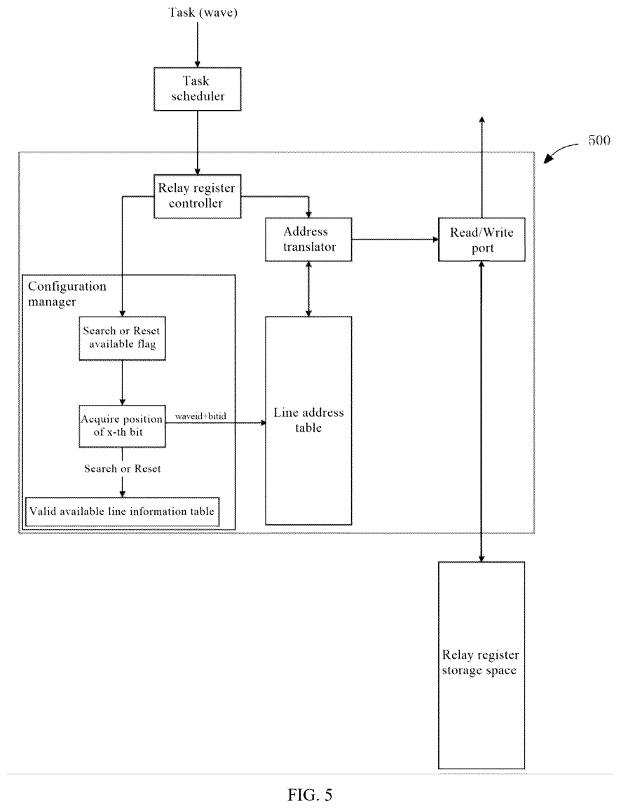

FIG. 5 shows a block diagram of an apparatus 500 for configuring a relay register module according to another embodiment of the present disclosure.

As shown in FIG. 5, the apparatus 500 may include a relay register controller, a configuration manager, an address translator, a line address table and a read/write port. In an alternative implementation, the apparatus 500 may include only the relay register controller, the configuration manager, the address translator and the line address table. In this case, the read/write port may be provided on the relay register module. The apparatus 500 may be implemented as the apparatus 400, with the only difference that the line address table in FIG. 5 is separated from the configuration manager and implemented independently.

In FIG. 5, relay register allocation is exemplarily performed in a wave32 and wave128 compatible mode: a total number of relay registers is K=M banks*N tasks*SIMD_Numb. When a program is started, the maximum relay register usage amount is configured first, for example, is set to T. Herein, aligned_size represents the number of DWs contained in relay register lines of an aligned single instance. Upon receiving a start allocation request for a task from the task scheduler, the relay register controller acquires the number of relay register lines from the start allocation request, which indicates the number of relay register lines to be allocated. In a case of determining that relay register configuration is required, it is determined that the task includes blocking information which includes that the relay register configuration is required. In a case of determining that the relay register configuration is not required, it is determined that the task is in a ready state. Here, the wave128 mode may be configured to 1, indicating that only 1 relay register line can be allocated to each segment (Seg), and 4 segments (Seg0, Seg1, Seg2, Seg3) correspond to 4 relay register lines. The wave32 mode may be configured to ((T+aligned_size−1)/aligned_size) lines, and a calculation result thereof is commonly 0, 1, 2, 3 or 4 relay register lines, corresponding to a relay register usage amount of 0, 2, 4, 6, 8 for each work item instance. Illustratively, when allocation of relay register lines to a task is not completed, it may be understood as that there is temporarily no idle relay register line available for allocation, and the task may wait to be allocated with a relay register line until another task is completed and a relay register line available for allocation is released. However, when the number of released relay register lines does not satisfy the number of relay register lines required in the start allocation request, the configuration manager will cause the allocation of the task to continue waiting until the number of released relay register lines satisfies the number of relay register lines required in the start allocation request.

In some optional embodiments, an allocation step for partial relay register lines may be performed for a task. Illustratively, when a task needs 4 relay register lines and currently there are only 2 idle relay register lines, an allocation step of the 2 relay register lines may be executed, and, in a case where another task is completed and more relay register lines available for allocation are released, an allocation step of the remaining 2 relay register lines is executed. When all relay register lines to be allocated to the task are allocated, the wake-up signal is sent to the task scheduler.

For example, when the wave32 needs to be configured with 2 relay register lines, the configuration manager search the valid available line information table from beginning to end to found that the x-th bit is identified as available (e.g., is set to 1), the bit is identified as used (e.g., is set to 0), so that the bit will not be occupied by other tasks. At this time, a value of x is filled as an index value into a corresponding entry of the line address table together with the serial number of the task. In one example, the valid available line information table may be set to a 48-bits valid flag table, in which each 1 bit indicates that one relay register line is valid and available. Generally, 1 represents “available”, and 0 represents “used”. It is essentially equivalent to searching that the x-th that is available, and then the x is filled into the line address table together with the serial number waveid of the task. Illustratively, the serial number waveid of the task may be used to manage the line address table, so that the pipeline may access the relay registers by simply sending the serial number of the task when accessing the relay registers. Illustratively, the valid available line information table may be continuously searched according to the number of relay registers allocated to the task, to configure a plurality of relay register lines for the task to use, and filling may be performed after every traversal. In this way, the serial number of the task may be associated with the available relay register line in the relay register module, so that only the serial number of the task is needed when the pipeline accesses the relay registers. When the task is finished and the allocated relay register lines are released, the corresponding bit in the valid available line address table is set to available through the entry in the line address table.

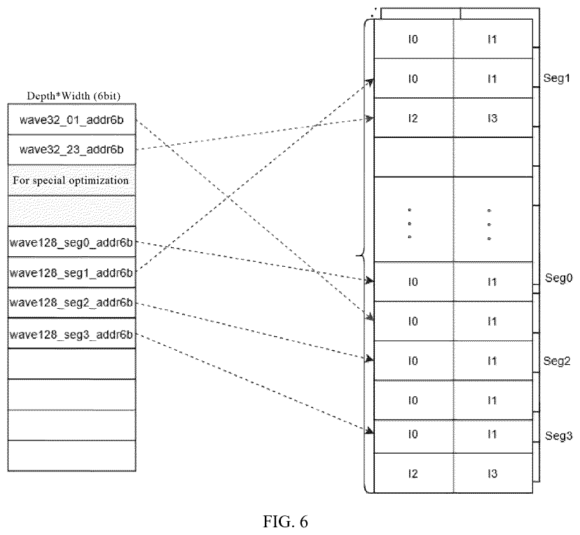

FIG. 6 shows a schematic diagram of dynamically allocating relay registers according to an embodiment of the present disclosure.

As shown in FIG. 6, when the dynamic allocation is completed, the wave32 is allocated with 2 relay register lines, and each segment of wave128 is allocated with one relay register line. A mapping structure is as shown in FIG. 6. It is obvious that more relay register lines may be allocated to each task in a case fewer tasks are simultaneously started. Illustratively, the wave32 is allocated with 4 relay register lines (for special optimization), and each segment of the wave128 is allocated with 2 relay register lines. Compared with a case of fixed bonding, for an application in which fewer tasks are simultaneously started due to a large use amount of general data registers of a task, more relay register resources may be dynamically allocated to each task, or more relay register resources may be dynamically allocated as the general data registers, so that pressure of simultaneous accesses to the general data registers of a plurality pipelines can be reduced, and an utilization rate of relay register resources can be improved.

As shown in FIG. 6, each work item instance in the same task has its own relay register space, and for the same task, after a previous instruction is written back, the relay register space can be immediately provided for use by a next instruction after hiding and delaying through internal instruction scheduling of the task, and when the next instruction is written back again, a previous result may be directly overwritten as long as the previous instruction is guaranteed to be used up.

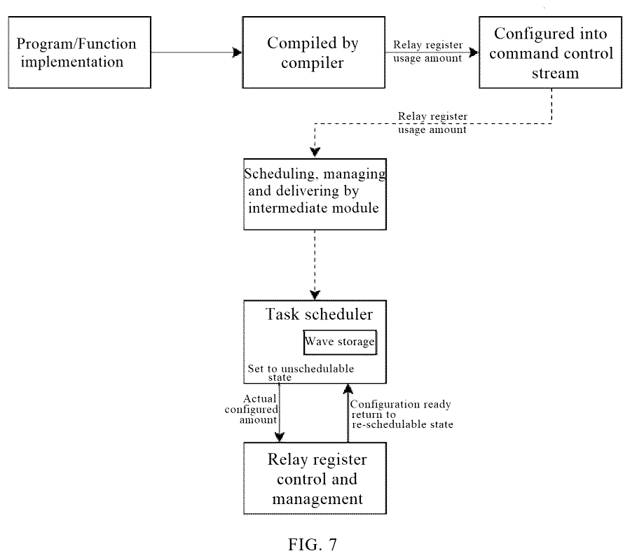

FIG. 7 shows a schematic diagram of interaction between a task scheduler and a relay register configuring apparatus according to an embodiment of the present disclosure.

As shown in FIG. 7, a program implementation is compiled by the compiler to configure a relay register usage amount. After the amount is configured, a software or drive module will configure it into a command control stream, and then manage and deliver the relay register usage amount through scheduling and management of intermediate modules, until it is transmitted into the task scheduler and stored in a wave storage. At this time, the task scheduler may set different usage amounts according to whether the relay register usage amount is 0, and here, according to different execution modes of wave configuration. If the relay register usage amount is 0, no relay register is allocated, and the wave is directly set to a ready state to enter a scheduling information queue for schedule and execution. When the relay register usage amount is not 0, the wave needs to be configured by the relay register configuring apparatus, and set to a blocked state indicating that configuration is not completed. When the configuration of the wave is completed, a monitor detects that the configuration of the wave is completed, so the blocked state is cleared, the wave entry is updated to the ready state, and the wave is updated to the ready state to enter the scheduling information queue for schedule and execution.

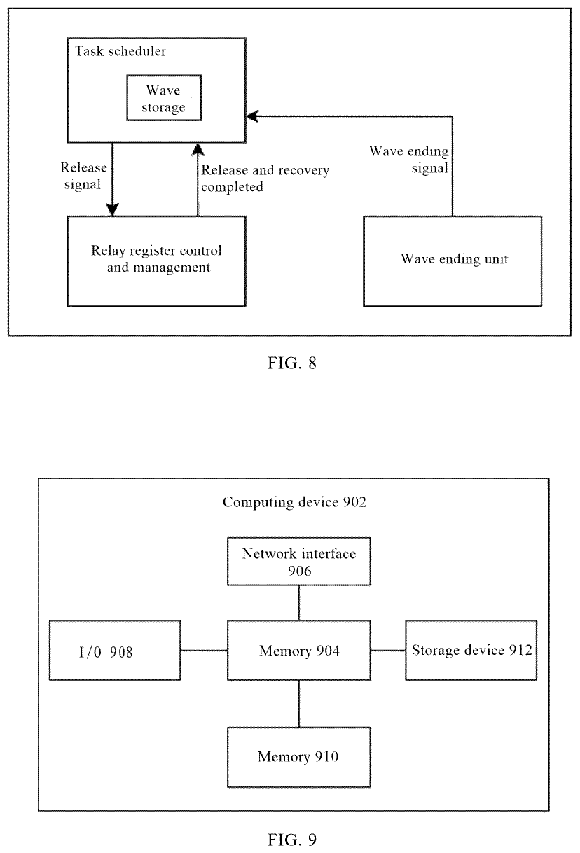

FIG. 8 shows a schematic diagram of interaction between a task scheduler and a relay register configuring apparatus according to another embodiment of the present disclosure.

As shown in FIG. 8, when the execution of the wave is finished, a wave ending unit sends an ending signal corresponding to the serial number of the wave to the task scheduler after executing an ending instruction. Upon receiving the ending signal, the task scheduler sends a release signal to the relay register configuring apparatus. After release and recovery of the relay register are finished, a release and recovery complete signal corresponding to the serial number of the wave is returned, then wave storage information is released, thereby completing a wave release ending operation.

In various embodiments, the apparatuses 300, 400, 500 may be used to perform the steps of any of the methods described above. Thus, any feature according to the method is applicable to the apparatuses 300, 400, 500, and vice versa.

Additionally or alternatively, the above method, universal docking module, service platform, or third party platform of the present application can be implemented on one or more computers or servers or similar devices by using computer processors, memory units, storage devices, computer software and other components. A high-level block diagram of such a computer or server is shown in FIG. 9. Herein, a computer, a server, or any other device that includes a processor is collectively referred to as a computing device. The computing device 902 includes a processor 904, which controls an operation of the computing device 902 by executing a computer program instruction defining overall operations. The computer program instruction may be stored in a storage device 912 (e.g., magnetic disk), and loaded into a memory 910 when the computer program instruction is to be executed. Therefore, the steps of the method described with reference to FIG. 1 may be defined by the computer program instruction stored in the memory 910 and/or the storage device 912, and controlled by the processor 904 for executing the computer program instruction. The computing device 902 further includes one or more network interfaces 906 configured to perform communication with other devices via a network. The computing device 902 further includes another input/output device 908 (e.g., a display, a keyboard, a mouse, a speaker, a button and the like) that enable an user interaction with the computing device 902. Those skilled in the art will recognize that actual embodiments of an actual computing device may contain other components as well, and FIG. 9 is a high-level representation of some components of such a computer for illustrative purposes.

The storage device 912 and the memory 910 each include a tangible and non-transitory computer-readable storage medium. The storage device 912 and the memory 910 may each include a high-speed random access memory, such as a dynamic random access memory (DRAM), a static random access memory (SRAM), a double data rate synchronous dynamic random access memory (DDRSRAM), or any other random access solid state memory device, and may include a non-volatile memory, such as one or more magnetic disk storage devices (such as an internal hard disk and a removable magnetic disk), magneto-optical disk storage devices, optical disk storage devices, flash memory devices, semiconductor memory devices (such as erasable programmable read only memories (EPROMs), or electrically erasable programmable read only memories (EEPROMs)), compact disk read only memories (CD-ROMs), digital versatile disk read only memory (DVD-ROM) disks, or other non-volatile solid state storage devices.

Another embodiment relates to a computer program product, which may be downloaded from the internet or stored on a storage medium. The computer program product includes an instruction which, when executed by a computing device or other similar apparatuses, causes the computing device to perform the method according to any one of the above embodiments.

In another embodiment, the method, the universal docking module, the service platform, or the third party platform described above may be implemented in a network-based cloud computing system. In such the network-based cloud computing system, a server is in communication with one or more client computers via a network. The client computers may communicate with the server, for example, via web browser applications that reside and run on the client computers. The client computers may store data on the server and access the data via the network. The client computers may transmit data requests or online service requests to the server via the network. The server may implement the requested services, and provide data to the client computer(s). The server may further transmit data adapted to cause the client computers to perform specified functions (e.g., computation, displaying of specified data on a screen, and the like). Some steps of the above method may be performed by the server or by other computers/processors in the network-based cloud computing system. Some steps of the above method may be implemented locally by the client computers in the network-based cloud computing system. The steps of the above method may be implemented by any combination of one or more devices in the network-based cloud computing system and the local client computers.

It will be appreciated that certain features of the present application, which are, for clarity, described in contexts of separate embodiments, may also be provided in combination in a single embodiment. Conversely, various features of the present application, which are, for brevity, described in contexts of a single embodiment, may also be provided separately or in any suitable sub-combination, or in any other embodiment of the present application. Certain features described in contexts of various embodiments should not be considered as essential features of those embodiments, unless the embodiment is invalid without those elements.

While the present application has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents, and patent applications mentioned in the present specification are incorporated herein in their entirety by reference, to the same extent as if each individual publication, patent, or patent application were specifically and particularly indicated to be incorporated herein by reference. In addition, citation or identification of any reference in the present application shall not be construed as an admission that such reference is available as prior art to the present application. Where section headings are used, they should not be construed as necessarily limiting.

What is claimed is:

1. A method for configuring a relay register module, characterized in that the method comprises:
receiving a start allocation request for at least one task sent by a task scheduler;
determining, based on the start allocation request, a number of relay registers to be allocated to each task of the at least one task;
allocating the corresponding number of relay registers to each task; and
sending a wake-up signal to the task scheduler in a case where allocation is completed, the wake-up signal is used by the task scheduler to start a task to which relay registers are allocated,
wherein the relay register module is configured to store an intermediate result obtained from an operation based on an instruction of the task.

2. The method according to claim 1, characterized in that the start allocation request comprises a working mode of the task and a number of relay registers to be allocated to each work item instance in the task, wherein determining, based on the start allocation request, the number of relay registers to be allocated to each task of the at least one task comprises:
determining the number of relay registers to be allocated to each task based on a granularity corresponding to the working mode of the task and the number of relay registers to be allocated to each work item instance in the task, wherein the granularity represents a maximum number of work item instances comprised in the corresponding task.

3. The method according to claim 2, characterized in that the number of relay registers to be allocated to each work item instance in the task is determined based on a defined number of tasks that are simultaneously started.

4. The method according to claim 2, characterized in that numbers of relay registers to be allocated to each work item instance in tasks of different working modes are different, and
numbers of relay registers to be allocated to each work item instance in tasks of the same working mode are same or different.

5. The method according to claim 1, characterized in that the number of relay registers to be allocated to each task is less than or equal to a reference value, wherein the reference value is determined based on a total number of the relay registers, a working mode of the task, and a configured maximum relay register usage amount.

6. The method according to claim 1, characterized in that the task comprises at least one work item instance, each work item instance is allocated with at least one relay register, and the method further comprises:
storing, in a case where a calculation result of a first instruction in the relay register is used up, a calculation result of a second instruction in the relay register, wherein the first instruction and the second instruction are instructions of the same work item instance, and the second instruction is a subsequent instruction of the first instruction.

7. The method according to claim 1, characterized in that allocating the corresponding number of relay registers to each task comprises:
determining, based on the number of relay registers to be allocated to the task, an available line allocated to the task in the relay register module, wherein the available line is a relay register line available for allocation; and
allocating relay registers in the available line to the task, and labeling the available line as an allocated relay register line.

8. The method according to claim 7, characterized in that the available line comprises an index value, the task comprises a serial number, and the method further comprises:
acquiring the serial number of the task and the index value of the available line allocated to the corresponding task, and recording the serial number and the index value in a line address table, wherein the serial number is used for managing the line address table.

9. The method according to claim 8, characterized in that the method further comprises:
in response to receiving an access request to the relay register module, generating a physical address of a relay register corresponding to the access request according to the serial number of the task comprised in the access request and the line address table,
wherein the physical address is used for accessing the relay register module.

10. The method according to claim 1, characterized in that the method further comprises:
in response to receiving a task ending signal, recovering relay registers allocated to a task corresponding to the task ending signal.

11. An electronic device, characterized in comprising: a processor; and
a memory configured to store a processor-executable instruction;
wherein the processor is configured to call the instruction stored in the memory to perform steps of:
receiving a start allocation request for at least one task sent by a task scheduler;
determining, based on the start allocation request, a number of relay registers to be allocated to each task of the at least one task;
allocating the corresponding number of relay registers to each task; and
sending a wake-up signal to the task scheduler in a case where allocation is completed, the wake-up signal is used by the task scheduler to start a task to which relay registers are allocated,
wherein the relay register module is configured to store an intermediate result obtained from an operation based on an instruction of the task.

12. The electronic device according to claim 11, characterized in that the start allocation request comprises a working mode of the task and a number of relay registers to be allocated to each work item instance in the task, wherein determining, based on the start allocation request, the number of relay registers to be allocated to each task of the at least one task comprises:
determining the number of relay registers to be allocated to each task based on a granularity corresponding to the working mode of the task and the number of relay registers to be allocated to each work item instance in the task, wherein the granularity represents a maximum number of work item instances comprised in the corresponding task.

13. The electronic device according to claim 12, characterized in that the number of relay registers to be allocated to each work item instance in the task is determined based on a defined number of tasks that are simultaneously started.

14. The electronic device according to claim 12, characterized in that numbers of relay registers to be allocated to each work item instance in tasks of different working modes are different, and
numbers of relay registers to be allocated to each work item instance in tasks of the same working mode are same or different.

15. The electronic device according to claim 11, characterized in that the number of relay registers to be allocated to each task is less than or equal to a reference value, wherein the reference value is determined based on a total number of the relay registers, a working mode of the task, and a configured maximum relay register usage amount.

16. The electronic device according to claim 11, characterized in that the task comprises at least one work item instance, each work item instance is allocated with at least one relay register, and the method further comprises:
storing, in a case where a calculation result of a first instruction in the relay register is used up, a calculation result of a second instruction in the relay register, wherein the first instruction and the second instruction are instructions of the same work item instance, and the second instruction is a subsequent instruction of the first instruction.

17. The electronic device according to claim 11, characterized in that allocating the corresponding number of relay registers to each task comprises:
determining, based on the number of relay registers to be allocated to the task, an available line allocated to the task in the relay register module, wherein the available line is a relay register line available for allocation; and
allocating relay registers in the available line to the task, and labeling the available line as an allocated relay register line.

18. The electronic device according to claim 17, characterized in that the available line comprises an index value, the task comprises a serial number, and the method further comprises:
acquiring the serial number of the task and the index value of the available line allocated to the corresponding task, and recording the serial number and the index value in a line address table, wherein the serial number is used for managing the line address table.

19. The electronic device according to claim 18, characterized in that the method further comprises:
in response to receiving an access request to the relay register module, generating a physical address of a relay register corresponding to the access request according to the serial number of the task comprised in the access request and the line address table; and/or
in response to receiving a task ending signal, recovering relay registers allocated to a task corresponding to the task ending signal,
wherein the physical address is used for accessing the relay register module.

20. A non-transitory computer-readable medium having an instruction stored thereon which, when executed, causes a computing device to perform the method according to claim 1.
